(19) United States
(12) Patent Application Publication
(10) Pub. No.: US 2010/0173226 A1
(43) Pub. Date: Jul. 8, 2010

(54) FUEL CELL

(75) Inventors: Hideyo Oomori, Susono-shi (JP); Masanori Yoshida, Sunto-gun (JP); Tatsuo Kawabata, Susono-shi (JP); Osamu Hamanoi, Susono-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi-ken (JP)

(21) Appl. No.: 12/601,720

(22) PCT Filed: May 27, 2008
(86) PCT No.: PCT/IB08/01336

§ 371 Date: Nov. 24, 2009

(30) Foreign Application Priority Data
May 28, 2007 (JP) 2007-140374

(51) Int. Cl. H01M 8/02

(52) U.S. Cl. 429/508

(57) ABSTRACT

A fuel cell in which stress that is caused in an electrolyte membrane is relaxed or absorbed is provided. The fuel cell includes A fuel cell includes an electrolyte membrane; a holding member that is used to hold the electrolyte membrane; and an elastic member that is arranged between the electrolyte membrane and the holding member so that the holding member holds the electrolyte membrane.

### BACKGROUND OF THE INVENTION

1. Field of the Invention

The invention relates generally to a fuel cell that includes an electrolyte membrane. More specifically, the invention relates to a technology for minimizing the possibility of a cross-leak that may be caused due to damage of the electrolyte membrane.

2. Description of the Related Art

For example, a proton-exchange membrane fuel cell (PEFC) is formed by stacking a predetermined number of cells. Each cell is formed by clamping a structural body between separators. In the structural body, a fuel electrode (anode) that has a catalyst layer and a diffusion layer is provided on one side of an electrolyte membrane and an air electrode (cathode) that also has a catalyst layer and a diffusion layer is provided the other side of the electrolyte membrane.

When a fuel electrode is provided to one side of an electrolyte membrane and an air electrode is provided on the other side of the electrolyte membrane, the electrolyte membrane may be held by a resin frame. For example, as shown in FIG. 7, a recess 51 is formed around the entire circumference of an inner face of a resin frame 50. Then, an outer edge 2a of an electrolyte membrane 2 is inserted into the recess 51. Sidewalls of the recess 51 and the outer edge 2a of the electrolyte membrane 2 are bonded together with an adhesive agent. In this way, the electrolyte membrane 2 is held by the resin frame 50.

Japanese Patent Application Publication No. 10-199551 (JP-A-10-199551) describes a technology related to a proton-exchange membrane fuel cell. According to JP-A-10-199551, joined bodies are formed by press-fitting an anode and a cathode into a first frame and a second frame, which are frame-shaped resin sheets, respectively. Then, an adhesive agent is applied to bonding faces of the frames of the joined bodies. An electrolyte membrane is clamped between these joined bodies. Japanese Patent Application Publication No. 2005-285677 (JP-A-2005-285677) and Japanese Patent Application Publication No. 08-185881 (JP-A-08-185881) each describe a technology related to a proton-exchange membrane fuel cell.

However, the method for holding an electrolyte membrane as shown in FIG. 7 has the following problem. An electrolyte membrane is formed of a fluorinated electrolyte membrane, for example, a perfluoro-sulfonate polymer. It is known that such fluorinated electrolyte membrane expands and contracts in its planner direction in accordance with the amount of water that is produced when a fuel cell generates electric power and that is contained within the fluorinated electrolyte membrane. As shown in FIG. 7, if the electrolyte membrane 2 is fixed to the resin frame 50 with an adhesive agent, stress is caused near an adhesion site (from the adhesion site) when the electrolyte membrane 2 expands or contracts. This stress causes a crack (indicated by a dash line X in FIG. 7) near the adhesion site of the electrolyte membrane 2. Accordingly, there is a possibility that a cross-leak may occur. A cross-leak is a phenomenon in which the fuel (hydrogen) supplied to a fuel electrode passes through the electrolyte membrane 2 and reaches an air electrode and/or the air (oxygen) supplied to the air electrode passes through the electrolyte membrane 2 and reaches fuel electrode.

### SUMMARY OF THE INVENTION

The invention provides a fuel cell in which stress that is caused in an electrolyte membrane is relaxed or absorbed.

A fuel cell according to the invention is structured as described below so that stress that is caused in an electrolyte membrane is relaxed or absorbed.

An aspect of the invention relates to a fuel cell that includes: an electrolyte membrane; a holding member that is used to hold the electrolyte membrane; and an elastic member that is arranged between the electrolyte membrane and the holding member so that the holding member holds the electrolyte membrane.

In the aspect of the invention described above, the elastic member may be bonded to the electrolyte membrane, or the electrolyte membrane may be clamped between portions of the elastic member.

According to the aspect of the invention described above, when the electrolyte membrane expands or contracts, stress that is caused in the electrolyte membrane is relaxed or absorbed due to elasticity of the elastic member.

In the aspect of the invention described above, the electrolyte membrane may include a center portion and a peripheral portion that is formed around the center portion and that contacts the elastic member when the electrolyte membrane is held by the holding member, and a molecular weight in the peripheral portion may be greater than a molecular weight in the center portion.

With this structure, it is possible to reduce the possibility that the electrolyte membrane will be damaged, because the strength of the peripheral portion, to which relatively high stress is applied, is increased.

In the aspect of the invention described above, the electrolyte membrane may be formed of multiple electrolyte membrane pieces that are connected to each other via the elastic member.

With this structure, the stress that is caused due to expansion or contraction of each electrolyte membrane piece is dispersed in the elastic member. Thus, the stress is relaxed or absorbed.

In the first aspect of the invention, the elastic member may have first contact portions that contact the electrolyte membrane so that the electrolyte membrane is clamped between the first contact portions of the elastic member, and second contact portions that contact the holding member when the first contact portions contact the electrolyte membrane so that the electrolyte membrane is kept clamped between the first contact portions. In addition, the first contact portions may be formed so as to deform in accordance with at least one of contraction and expansion of the electrolyte membrane that is clamped between the first contact portions, whereas the second contact portions may be formed so as not to deform even when the electrolyte membrane contracts or expands.

With this structure, it is possible to relax or absorb the stress that is caused in the electrolyte membrane, because the first contact portions move (deform) to some extent in accordance with contraction or expansion of the electrolyte membrane.

In this configuration, a friction coefficient of the first contact portion may be smaller than a friction coefficient of the second contact portion when the electrolyte membrane is clamped between the first contact portions. In other words, the friction between the first contact portion and the electrolyte membrane may be smaller than the friction between the second contact portion and the holding member.

Alternatively, the first contact portion may be formed in such a manner that the stress, which is caused due to contraction of the electrolyte membrane and which is directed in the planar direction of the electrolyte membrane, is partially directed in the direction that is perpendicular to the planar direction.

According to the aspect of the invention, it is possible to provide the fuel cell in which the stress that is caused in the electrolyte membrane is relaxed or absorbed.

### BRIEF DESCRIPTION OF THE DRAWINGS

The foregoing and further features and advantages of the invention will become apparent from the following description of example embodiments with reference to the accompanying drawings, wherein the same or corresponding portions will be denoted by the same reference numerals and wherein:

FIG. 1 is a view showing an example of the structure of a fuel cell according to the invention;

FIG. 2A is a left lateral view showing components of the fuel cell shown in FIG. 1, other than separators and electrodes, according to a first embodiment of the invention;

FIG. 2B is a partial cross-sectional view taken along the line A-A in FIG. 2A;

FIG. 3A is a view showing a modified example 1 of the first embodiment of the invention;

FIG. 3B is a view showing a modified example 2 of the first embodiment of the invention;

FIG. 3C is a view showing a modified example 3 of the first embodiment of the invention;

FIG. 3D is a view showing a modified example 4 of the first embodiment of the invention;

FIG. 4 is a view showing components of a fuel cell according to a second embodiment of the invention;

FIG. 5A is a view showing components of a fuel cell according to a third embodiment of the invention;

FIG. 5B is a partial cross-sectional view showing the components in FIG. 5A, which is taken along the line B-B in FIG. 5A;

FIG. 5C is a view showing a modified example of the third embodiment of the invention;

FIG. 6A is a view showing components of a fuel cell according to a fourth embodiment of the invention;

FIG. 6B is a partial cross-sectional view showing the components in FIG. 6A, which is taken along the line C-C in FIG. 6A; and

FIG. 7 is a view illustrating an example of a method for holding an electrolyte membrane.

### DETAILED DESCRIPTION OF THE EXAMPLE EMBODIMENTS

Hereafter, example embodiments of the invention will be described in detail with reference to the accompanying drawings. It is, however, to be understood that the invention is not limited to the following embodiments.

### First Embodiment of the Invention

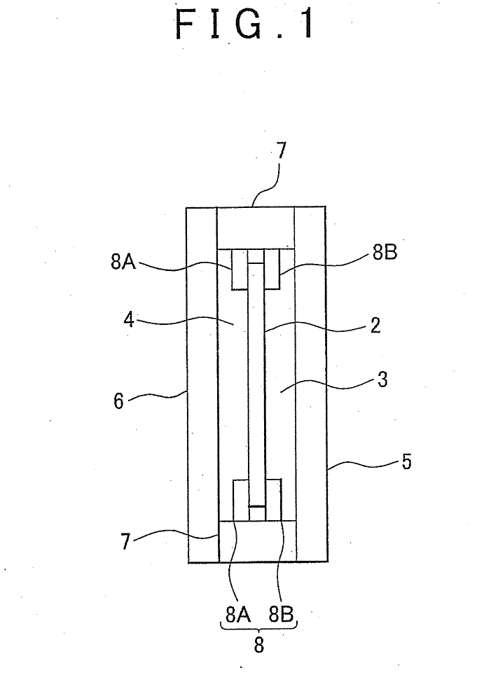

FIG. 1 is a view schematically showing one of cells that constitute a proton-exchange membrane fuel cell (PEFC), as an example of a fuel cell that has an electrolyte membrane. As shown in FIG. 1, a cell 1 of a fuel cell includes a polymer electrolyte membrane 2 (hereinafter, referred to as “electrolyte membrane 2”), a fuel electrode (anode) 3, an air electrode (oxidant electrode; cathode) 4, a fuel electrode-side separator 5, and an air electrode-side separator 6. The fuel electrode 3 is provided on one side of the electrolyte membrane 2, and the air electrode 4 is provided on the other side of the electrolyte membrane 2. The electrolyte membrane 2 is sandwiched between the fuel electrode 3 and the air electrode 4. The fuel electrode 3 is sandwiched between the fuel electrode-side separator 5 and the electrolyte membrane 2, and the air electrode 4 is sandwiched between the air electrode-side separator 6 and the electrolyte membrane 2.

The fuel electrode 3 has a diffusion layer and a catalyst layer. The fuel which contains, for example, hydrogen gas or hydrogen-rich gas is supplied to the fuel electrode 3 through a fuel supply system (not shown). The fuel supplied to the fuel electrode 3 diffuses in the diffusion layer and reaches the catalyst layer. When hydrogen reaches the catalyst layer, hydrogen is separated into a proton (hydrogen ion) and an electron. The hydrogen ion moves to the air electrode 4 through the electrolyte membrane 2, and the electron moves to the air electrode 4 through a line outside the cell.

The air electrode 4 also has a diffusion layer and a catalyst layer. The oxidant gas, for example, air is supplied to the air electrode 4 through an oxidant supply system. The oxidant gas supplied to the air electrode 4 diffuses in the diffusion layer and reaches the catalyst layer. In the catalyst layer, the oxidant gas, the hydrogen ions that reach the air electrode 4 through the electrolyte membrane 2, and the electrons that reach the air electrode 4 through the line outside the cell, react with each other to produce water. When such reaction occurs at the fuel electrode 3 and the air electrode 4, the electrons that move through the line outside the cell are used as the electric power for an electrical load (not shown) that is arranged between the terminals of the cell 1 and connected to the terminals of the cell 1.

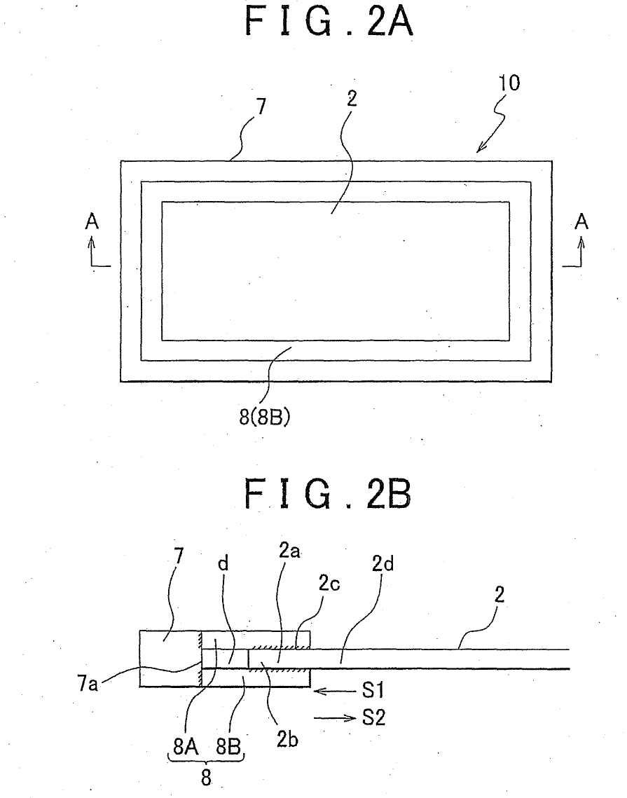

The electrolyte membrane 2 is formed of a fluorinated electrolyte membrane, for example, a perfluoro-sulfonate polymer. The electrolyte membrane 2 is held by a resin frame 7 via an elastic member 8. The resin frame 7 serves as a holding member. FIG. 2A is an enlarged left lateral view showing components 10 of the cell 1 in FIG. 1, other than fuel electrode 3, the air electrode 4, and the separators 5 and 6. FIG. 2B is a partial cross-sectional view showing the components 10 in FIG. 2A, which is taken along the line A-A in FIG. 2A. FIG. 2B shows the left-side portions of the components 10 in FIG. 2A.

As shown in FIG. 2A and FIG. 2B, the resin frame 7 has a rectangular frame-shape, and is formed in such a manner that the in-frame dimensions of the frame 7 are larger than the outer dimensions of the rectangular electrolyte membrane 2. The elastic member (stress absorbing member) 8 is provided within the resin frame 7 to hold the electrolyte membrane 2.

The elastic member 8 is formed of, for example, rubber, more specifically, silicon rubber, fluorine-containing rubber, or ethylene-propylene rubber (EPDM). The elastic member 8 includes two rectangular frame-shaped frame members 8A and 8B. The outer dimensions of each of the frame members 8A and 8B are substantially equal to the in-frame dimensions of the resin frame 7. In the resin frame 7, the frame members 8A and 8B are provided in substantially parallel to each other with a space d left therebetween. Outer side faces of the frame members 8A and 8B are bonded to an in-frame side face 7a of the resin frame 7 with an adhesive agent. The space d between the frame members 8A and 8B is substantially equal to or slightly smaller than the thickness of the electrolyte membrane 2. An outer edge 2a of the electrolyte membrane 2 is inserted into the space d formed between the frame members 8A and 8B. Contacting faces 2a and 2b of the outer edge 2a, which contact the frame members 8A and 8B, are bonded to the frame members 8A and 8B, respectively, with an adhesive agent. Thus, sealing is provided between the contact faces 2a and 2b and the frame members 8A and 8B.

The frame members 8A and 8B are formed so as to expand and contract in accordance with contraction and expansion of the electrolyte membrane 2 in its planner direction. More specifically, when the cell 1 generates electric power, the reaction at the air electrode 4 produces water. If the electrolyte membrane 2 absorbs the produced water, the electrolyte membrane 2 expands in its planner direction. Expansion causes stress, which develops outward in the planar direction (indicated by an arrow S1), in an area near an adhesion site 2d of the electrolyte membrane 2. The elastic member 8, which includes the frame members 8A and 8B, contracts to some extent due to the stress S1, because the elastic member 8 has inherent elasticity. Accordingly, the stress S1 due to expansion of the electrolyte membrane 2 is relaxed. The elastic member 8 may be capable of contracting by a certain amount so as to absorb the stress S1.

On the other hand, when the cell 1 stops generating electric power, the produced water evaporates, and the electrolyte dries, the electrolyte membrane 2 contracts in its planner direction. Contraction causes stress 2, which develops inward in the planar direction (indicated by an arrow S2), in the area near the adhesion site 2d of the electrolyte membrane 2, because adhesion site 2d is pulled toward the center of the electrolyte membrane 2. The elastic member 8, that is formed of the frame members 8A and 8B, expands to some extent) in accordance with contraction of the electrolyte membrane 2, because the elastic member 8 has the inherent elasticity. Accordingly, the stress S2, which is caused due to contraction of the electrolyte membrane 2 and which develops in the direction in which the adhesion site 2d is pulled, is relaxed. The elastic member 8 may be capable of expanding by a certain amount so as to absorb the stress S2.

As described above, with the fuel cell that includes the components 10 according to the first embodiment of the invention, the electrolyte membrane 2 is held by the resin frame 7 via the elastic member 8. In other words, the elastic member 8 is provided between the electrolyte membrane 2 and the resin frame 7. The elastic member 8 is formed so as to expand and contract in accordance with contraction and expansion of the electrolyte membrane 2. Accordingly, the stress S1 caused due to expansion and the stress S2 caused due to contraction of the electrolyte membrane 2 are relaxed. Thus, it is possible to suppress formation of a crack in the electrolyte membrane 2, which may cause a cross-leak.

As described above, the elastic member 8, which is formed of the frame members 8A and 8B and which is provided within the frame 7, holds the electrolyte membrane 2. Thus, the electrolyte membrane 2 is held by the frame 7. Instead of this structure, the following structures may be employed.

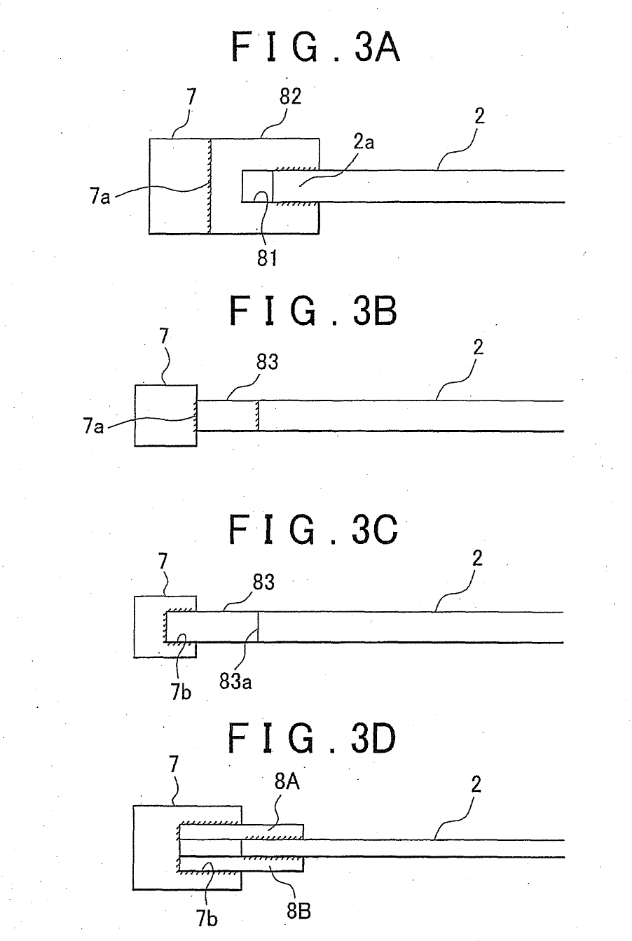

For example, as shown in a modified example 1 in FIG. 3A, instead of using the elastic member 8, which is formed of the frame members 8A and 8B, an elastic member 82 may be used. The elastic member 82 has a rectangular frame shape, and a recess (groove) 81 is formed around the entire circumference of an in-frame side face of the elastic member 82. The cross-section of the elastic member 82 may be in a U-shape. An outer face of the elastic member 82 is bonded to the in-frame side face 7a of the resin frame 7 with an adhesive agent. The outer edge 2a of the electrolyte membrane 2 is inserted into the recess 81. Side walls of the recess 81 and the both faces of the outer edge 2a are bonded together with an adhesive agent.

Alternatively, as shown in a modified example 2 in FIG. 3B, an elastic member 83 may be used. The elastic member 83 has a rectangular frame shape. An outer side face of the elastic member 83 is bonded to the in-frame side face 7a of the resin frame 7 with an adhesive agent. An inner side face 83a of the elastic member 83 is bonded to a face of the electrolyte membrane 2, which extends the in thickness direction of the electrolyte membrane 2 (outer side face), with an adhesive agent.

Further alternatively, as shown in a modified example 3 in FIG. 3C, the resin frame 7, which has a recess (groove) 7b that is formed around the entire circumference of the in-frame side face 7a, may be used. The outer edge of the elastic member 83 is inserted into the recess 7b, and the walls of the recess 7b and the outer edge of the elastic member 82 are bonded together with an adhesive agent.

Still further alternatively, as shown in a modified example 4 in FIG. 3D, the resin frame 7, which has the recess (groove) 7b that is formed in the entire circumference of the in-frame side face 7a, is used. A portion of each of the frame members 8A and 8B is inserted into the recess 7b, and the frame members 8A and 8B are bonded to inner walls of the recess 7b with an adhesive agent.

As described above, the fuel cell according to the invention may have any structure as long as the electrolyte membrane 2 is held by the resin frame 7 via an elastic member, and stress caused due to expansion and contraction of the electrolyte membrane 2 is absorbed by the elastic member to some extent. Instead of above-described types of rubber, any material that expands and contracts in accordance with contraction and expansion of the electrolyte membrane may be selected as the elastic member. It is preferable to use an acid-resisting material that does not deteriorate even when the fuel cell is operating at a high temperature within the operation temperature. The operation temperature of a proton-exchange membrane fuel cell is approximately 100 degrees Celsius.

### Second Embodiment of the Invention

Next, a fuel cell according to a second embodiment of the invention will be described. The fuel cell according to the second embodiment of the invention has the structures common to the fuel cell according to the first embodiment of the invention. Therefore, mainly, differences between the first and second embodiments will be described, and descriptions concerning the common structures will be omitted.

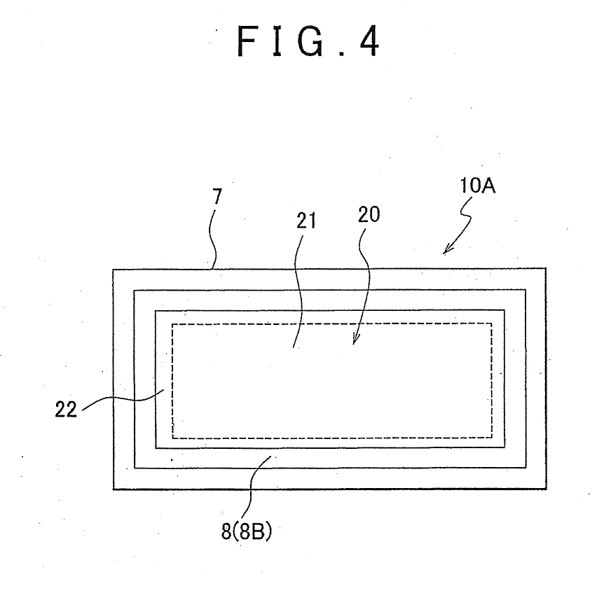

FIG. 4 is a view showing components 10A of a fuel cell according to the second embodiment of the invention. As shown in FIG. 4, the first embodiment and the second embodiment are the same in that a rectangular electrolyte membrane 20 is held by the resin frame 7 via the elastic member 8.

However, the electrolyte membrane 20 according to the second embodiment of the invention has a center portion 21, and a peripheral portion (outer portion) 22 that surrounds the center portion 21. The peripheral portion 22 is the area that is defined by a solid line indicating the boundary between the elastic member 8 and the electrolyte membrane 20 and a dash line drawn on the electrolyte membrane 20. The electrolyte membrane 20 is formed in such a manner that the molecular weight in the peripheral portion 22 is greater than the molecular weight in the center portion 21. In other words, the thickness of the peripheral portion 22 of the electrolyte membrane 20 is greater than the thickness of the center portion 21 of the electrolyte membrane 20.

The elastic member 8 is formed of, as in the first embodiment of the invention, the frame-shaped frame members 8A and 8B (see FIG. 21B). The peripheral portion 22 of the electrolyte membrane 20, which has the greater molecular weight, is partially inserted into the space d left between the frame members 8A and 8B. Contacting faces of the peripheral portion 22, which contact the frame members 8A and 8B, are bonded to the frame members 8A and 8B with an adhesive agent

Because the molecular weight of the peripheral portion 22 is greater than the molecular weight of the center portion 21, the peripheral portion 22 is provided with a higher strength to endure stress caused due to expansion and contraction of the electrolyte membrane 20. In addition, because the molecular weight of the center portion 21 is smaller than the molecular weight of the peripheral portion 22, it is possible to maintain the proton movement in an appropriate condition. The elastic member 8 relaxes the stress caused due to expansion and contraction of the electrolyte membrane 20, according to the second embodiment of the invention, as according to the first embodiment of the invention.

### Third Embodiment of the Invention

Next, a fuel cell according to a third embodiment of the invention will be described. The fuel cell according to the third embodiment of the invention has the structures common to the fuel cell according to the first embodiment of the invention. Therefore, mainly, differences between the first and third embodiments will be described, and descriptions concerning the common structures will be omitted.

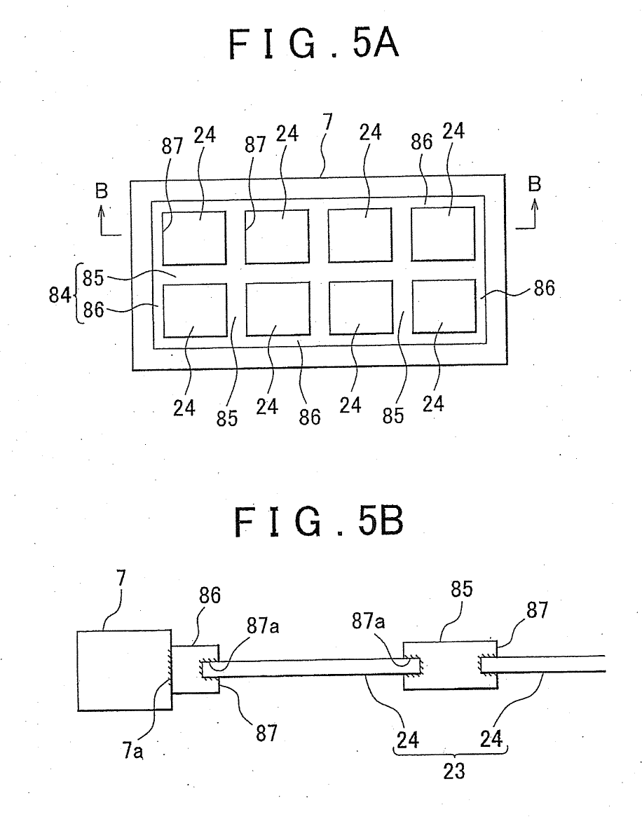

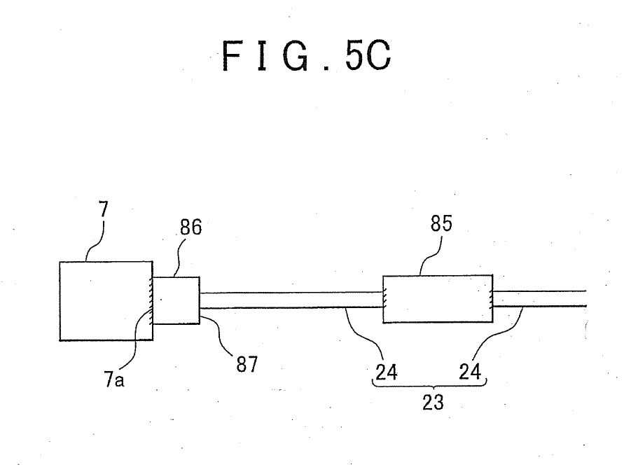

FIG. 5A is a view showing components 10B of a fuel cell according to the third embodiment of the invention. FIG. 5B is a partial cross-sectional view taken along the line B-B in FIG. 5A, which shows the components 10B.

As shown in FIG. 5A and FIG. 5B, an electrolyte membrane 23 according to the third embodiment of the invention is formed of multiple membrane pieces 24. The membrane pieces 24 are aligned in rows at predetermined intervals and also aligned in columns at the predetermined intervals. An elastic member 84 is formed by integrating a grid portion 85 with a frame portion 86. The grid portion 85 has a function of connecting the multiple membrane pieces 24 to each other. The frame portion 86 is formed so as to surround the periphery of the multiple membrane pieces 24. The elastic member 84 has a rectangular shape as a whole, and has holes 87 in which the membrane pieces 24 are fitted.

As shown in FIG. 5B, the elastic member 84 has recesses (grooves) 87a that are formed in the side faces of the respective holes 87. When the outer edges of the membrane pieces 24 are fitted in the recesses 87a, the membrane pieces 24 are fitted into the holes 87. The membrane pieces 24 and walls of the recesses 87a are bonded together with an adhesive agent to provide sealing therebetween. In this way, the membrane pieces 24 are held by the elastic member 84.

An outer side face of the elastic member 84 is bonded to the in-frame side face 7a of the resin frame 7 with an adhesive agent. Thus, the electrolyte membrane 23 that is formed of the multiple membrane pieces 24 is held by the resin frame 7 via the elastic member 84.

For example, an insulating material, of which the Young ratio is between approximately 1 Mpa to approximately 10 Mpa, may be used as the elastic member 84.

For example, the rubbers described in the first embodiment of the invention may be used as the elastic member 84. The beam length of the grid portion 85 is set in such a manner that the stresses caused by expansion and contraction of the adjacent membrane pieces 24 are absorbed. In addition, the beam length of the frame portion 86 is equal or greater than a half of the beam length of the grid portion 85.

A structure according to a modified example of the third embodiment of the invention shown in FIG. 5C may be employed. In the structure, the elastic member 84 does not have recesses (grooves) 87a in the side faces of the holes 87. The side faces of the holes 87 and side faces of the membrane pieces 24 are bonded together with an adhesive agent. In addition, it is preferable that each piece of film 24 be formed in a square so that the stresses due to expansion and contraction of the membrane pieces 24 are substantially equal to each other.

With the components 10B according to the third embodiment of the invention, because the elastic member 84, which includes the grid portion 85 and frame portion 86, expands and contracts in accordance with contraction and expansion of the membrane pieces 24, the stress is dispersed in the grid portion 85 and the frame portion 86. Accordingly the stress is relaxed or absorbed. Thus, it is possible to suppress formation of a crack in the membrane pieces 24, which may cause a cross-leak.

### Fourth Embodiment of the Invention

Next, a fuel cell according to a fourth embodiment of the invention will be described. The fuel cell according to the fourth embodiment of the invention has the structures common to the fuel cell according to the first embodiment of the invention. Therefore, mainly, differences between the first and third embodiments will be described, and descriptions concerning the common structures will be omitted.

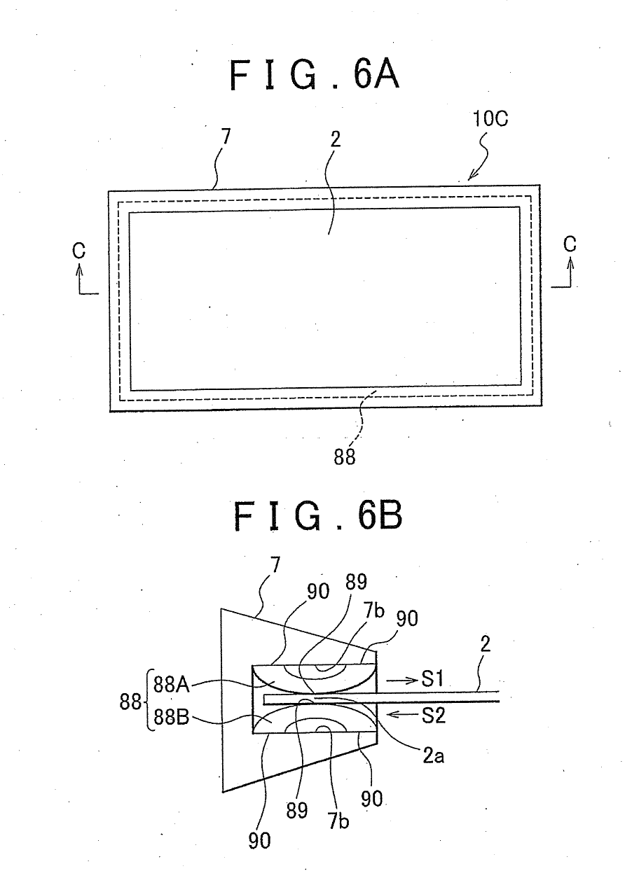

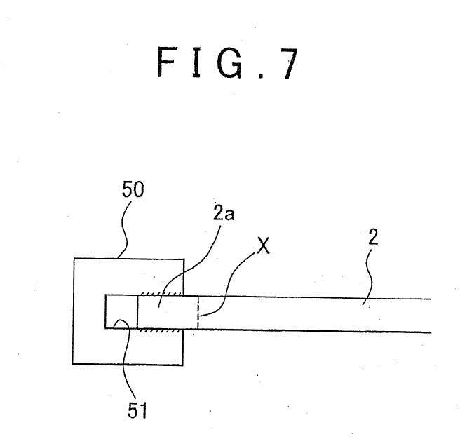

FIG. 6A is a view showing components 10C of a fuel cell according to the fourth embodiment of the invention. FIG. 6B is a partial cross-sectional view taken along the line C-C in FIG. 6A, which shows the components 10C. As shown in FIG. 6A and FIG. 6B, the frame 7 has the recess (groove) 7b that is formed in the entire circumference of the in-frame side face. In the recess 7b, an elastic member 88 that is formed of frame-shaped frame members 88A and 88B is provided. The frame-shaped frame members 88A and 88B each have an arched-shape (curved shape) in the cross section. The face of each of the frame-shaped frame members 88A and 88B, which is closer to the center axis of the recess 7b, is formed of a curved face 89. Base faces 90 of each of the frame-shaped frame members 88A and 88B (the face that is closer to the frame 7) contact the side wall of the recess 7b.

In the recess 7b, the outer edge 2a of the electrolyte membrane 2 is inserted between the curved faces 89 of the elastic the frame-shaped frame members 88A and 88B, which face each other. In this state, the outer edge 2a is sandwiched between the curved faces 89 of the frame members 88A and 88B (the faces that contact the electrolyte membrane 2). In addition, the base faces 90 of the frame members 88A and 88B, which are closer to the frame 7, contact the side walls of the recess 7b. Accordingly, the condition in which the outer edge 2a is sandwiched between the curved faces 89 is maintained. The electrolyte membrane 2 is held by the resin frame 7, which serves as a holding member, via the elastic member 8. Accordingly, sealing is provided between the outer edge 2a of the electrolyte membrane 2 and the frame members 88A and 88B.

The components 10C according to the fourth embodiment of the invention are different from the components according to each of the first to third embodiments of the invention in that the elastic member 88 is bonded to neither the frame 7 nor the electrolyte membrane 2 with an adhesive agent. With these components 10C, when the electrolyte membrane 2 expands, the electrolyte membrane 2 expands outward in the planner direction. The friction coefficient of the curved faces 89 of the frame-shaped frame members 88A and 88B (the faces that contact the electrolyte membrane 2) is smaller than the friction coefficient of the base faces 90 that contact the frame 7 which serves as a holding member. The friction coefficient of the curved face 89 corresponds to the friction between the curved face 89 and the outer edge 2a of the electrolyte membrane 2. The friction coefficient of the base faces 90 corresponds to the friction between the base faces 90 and the frame 7. In the fourth embodiment of the invention, the contact area between the base faces 90 and the frame 7 is larger than the contact area between the curved face 89 and the outer edge 2a of the electrolyte membrane 2. Accordingly, the friction coefficient of the base faces 90 that contact the frame 7 is larger than the friction coefficient of the curved face 89 of the each of the frame-shaped frame members 88A and 88B.

When the electrolyte membrane 2 expands, the outer edge 2a of the electrolyte membrane 2 moves outward in the planner direction against a force with which the outer edge 2a is clamped between the frame-shaped frame members 88A and 88B. At this time, the curved faces 89 of the frame-shaped frame members 88A and 88B, which contact the outer edge 2a, deform in accordance with the movement of the outer edge 2a of the electrolyte membrane 2. That is, the curved faces 89 bow outward. On the other hand, the base faces 90 that contact the frame 7 do not deform in accordance with the movement of the outer edge 2a of the electrolyte.

Because the curved face 89 deforms, the stress S1, which is directed outward in the planner direction of the electrolyte membrane 2, is partially directed in the direction perpendicular to the planner direction. Thus, it is possible to relax or absorb the stress that is caused near the contact portion. The contact portion corresponds to the curved faces 89, and is the area where the elastic member 8 which is formed of the frame members 88A and 88B contacts the electrolyte membrane 2.

When the electrolyte membrane 2 contracts, the outer edge 2a of the electrolyte membrane 2 moves inward in the planner direction. In other words, the electrolyte membrane 2 contracts toward its center in the planer direction. At this time, the outer edge 2a of the electrolyte membrane 2 moves inward against a force with which the outer edge 2a of the electrolyte membrane 2 is clamped between the frame-shaped frame members 88A and 88B. At that time, the curved faces 89 of the frame-shaped frame members 88A and 88B, which contact the outer edge 2a, deform in accordance with the movement of the outer edge 2a of the electrolyte membrane 2. That is, the curved faces 89 bow inward. On the other hand, the base faces 90 that contact the frame 7 do not deform in accordance with the movement of the outer edge 2a of the electrolyte membrane 2.

Because the curved face 89 deforms, the stress S2, which is directed inward in the planner direction of the electrolyte membrane 2, is partially directed in the direction perpendicular to the planner direction. Thus, it is possible to relax or absorb the stress that is caused near the contact portion. The contact portion corresponds to the curved faces 89, and is the area where the elastic member 8 which is formed of the frame members 88A and 88B contacts the electrolyte membrane 2.

According to the fourth embodiment of the invention, the curved faces 89 of the frame-shaped frame members 88A and 88B, which constitute the elastic member 88, move (deform) to some extent in accordance with at least one of expansion and contraction of the electrolyte membrane 2. Accordingly, it is possible to relax or absorb the stress that is caused due to expansion or contraction of the electrolyte membrane 2.

In the fourth embodiment of the invention, each of the frame-shaped frame members 88A and 88B is formed, in an arched shape in the cross section. The frame-shaped frame members 88A and 88B have curved faces 89, which correspond to the contact portion at which the frame members 88A and 88B contact the electrolyte membrane 2. The two base faces 90, which correspond to the bases of the arched shapes, contact the side walls of the recess 7b. Alternatively, the base face 90, which contacts the frame 7 (recess 7b ), may be formed of one single face. In addition, the elastic member 88 (frame members 88A and 88B) may have any cross sectional shape, as long as a portion which contacts the electrolyte membrane 2 deforms to relax or absorb the stress. For example, the curved faces 89 may be replaced with plane faces.

Instead of the above-described structure, a structure in which the base faces 90 of the frame-shaped frame members 88A and 88B, which contact the frame 7 (recess 7b), may be bonded to the side walls of the recess 7b with an adhesive agent may be employed. Alternatively, a structure described below may be employed. In the structure, the frame-shaped frame members 88A and 88B do not deform in accordance with expansion and contraction of the electrolyte membrane 2 but the outer edge 2a of the electrolyte membrane 2 slides between the frame-shaped frame members 88A and 88B in accordance with expansion and contraction of the electrolyte membrane 2.

The first, second, third, and fourth embodiments described above may be selectively combined with each other within the scope of the invention.

1. A fuel cell, comprising:
an electrolyte membrane;
a holding member that is used to hold the electrolyte membrane; and
an elastic member that is arranged between the electrolyte membrane and the holding member so that the holding member holds the electrolyte membrane,
wherein a space is provided between the electrolyte membrane and the holding member.

2. The fuel cell according to claim 1,
wherein:
the elastic member includes a first elastic member and a second elastic member, and
the electrolyte membrane is clamped between the first elastic member and the second elastic member.

3. The fuel cell according to claim 1,
wherein:
a recess is formed in the elastic member, and
the electrolyte membrane is inserted in the recess so that the electrolyte membrane is held.

4. The fuel cell according to claim 1,
wherein:
a recess is formed in the holding member, and
the elastic member is inserted in the recess so that the electrolyte membrane is held.

5. The fuel cell according to claim 1,
wherein:
a recess is formed in the holding member;
the elastic member includes a first elastic member and a second elastic member; and
the electrolyte membrane is clamped between the first elastic member and the second elastic member in the recess.

6. The fuel cell according to claim 1,
wherein:
the electrolyte membrane includes a center portion and a peripheral portion that is formed around the center portion and that contacts the elastic member when the electrolyte membrane is held by the holding member, and
a molecular weight in the peripheral portion is greater than a molecular weight in the center portion.

7. The fuel cell according to claim 1, wherein a thickness of the electrolyte membrane is greater in the peripheral portion than in the center portion.

8. The fuel cell according to claim 1,
wherein the electrolyte membrane is formed of multiple electrolyte membrane pieces that are connected to each other via the elastic member.

9. The fuel cell according to claim 8,
wherein:
the elastic member includes a grid portion and a frame portion,
the grid portion connects the electrolyte membrane pieces to each other; and
the frame portion connects the electrolyte membrane pieces and the holding member to each other.

10. The fuel cell according to claim 9,
wherein:
recesses are formed in the grid portion and the frame portion of the elastic member, and
the electrolyte membrane pieces are inserted in the recesses.

11. The fuel cell according to claim 9, wherein a beam length of the grid portion is equal to or greater than a half of a beam length of the grid portion.

12. The fuel cell according to claim 1,
wherein:
the elastic member has first contact portions that contact the electrolyte membrane so that the electrolyte membrane is clamped between the first contact portions of the elastic member, and second contact portions that contact the holding member when the first contact portions contact the electrolyte membrane so that the electrolyte membrane is kept clamped between the first contact portions, and
the first contact portions deform in accordance with at least one of contraction and expansion of the electrolyte membrane that is clamped between the first contact portions, whereas the second contact portions do not deform even when the electrolyte membrane contracts or expands.

13. The fuel cell according to claim 1,
wherein:
the elastic member has first contact portions that contact the electrolyte membrane so that the electrolyte membrane is clamped between the first contact portions of the elastic member, and second contact portions that contact the holding member when the first contact portions contact the electrolyte membrane so that the electrolyte membrane is kept clamped between the first contact portions, and
a friction coefficient of the first contact portion is smaller than a friction coefficient of the second contact portion.

14. The fuel cell according to claim 13, wherein the friction coefficients are controlled based on a relationship between an area of the first contact portion and an area of the second contact portion.

15. The fuel cell according to claim 1, wherein a recess is formed in the holding member, wherein the elastic members each have an arched-shape in cross-section and the face of each of the elastic members, which is close to the center axis of the recess, is formed of a curved face.
